(19) United States
(12) Patent Application Publication
(10) Pub. No.: US 2012/0095996 A1
(43) Pub. Date: Apr. 19, 2012

(54) SEARCH IN A MULTI-RELATIONSHIP SOCIAL NETWORK

(76) Inventors: Bruno Dumant, Verneuil sur Seine (FR); Xavier Noelle, Paris (FR); Alexis L. Naibo, Levallois-Perret (FR)

(21) Appl. No.: 12/904,402

(22) Filed: Oct. 14, 2010

(51) Int. Cl. G06F 17/30

(52) U.S. Cl. 707/728; 707/758; 707/741; 707/E17.014

(57) ABSTRACT

Some aspects include reception, from an entity, of a search query to identify entities, determination of one or more entity clusters associated with the entity, determination of a search result based on the search query, the search result including two or more result entities, and presentation of the two or more result entities in an order based on the one or more entity clusters.

According to some aspects, the search query is modified based on the determined one or more entity clusters, the search result is determined based on the modified search query and associates a respective relevance score with each result entity. The relevance score indicates a relevance of a result entity to the modified search query, and the two or more result entities are presented according to their respective relevance scores.

In some aspects, each of the two or more result entities is associated with a respective relevance score, two of the two or more result entities are determined to be associated with a same relevance score, and the relevance score associated with each of the two of the two or more result entities is modified based on the one or more entity clusters associated with the entity, and on entity clusters associated with each of the two of the two or more result entities. Moreover, the two of the two or more result entities are presented according to their modified relevance scores.

### BACKGROUND

Modern organizations store electronic information associated with one or more entities, such as people, organizations, or the like. For example, different systems within an enterprise may store data representing personal contact information, management structures, electronic mail communications, project assignments, etc. This data may suggest different types of relationships (e.g., manager-managee, same project, same location, etc.) between people within the enterprise.

Commonly-assigned co-pending U.S. patent application Ser. No. 12/253,562 describes systems to populate a social network based on disparate enterprise source data in order to expose various relationships between entities. Commonly-assigned co-pending U.S. patent application Ser. No. 12/253,518 describes a system to search for entities within such a social network.

Conventional search engines employ scoring algorithms to determine “best” results. For example, a person may submit the search query “Paris developer” and receive a list of results (e.g., entities) ordered by relevance. The list is unaffected by the relationships of the person who submitted the search query. Accordingly, the order of the list is the same regardless of who submitted the search query.

Systems are desired to produce search results which are influenced by relationships of the searching entity. Systems are also desired in which different types of relationships provide different degrees of influence over the search results.

### BRIEF DESCRIPTION OF THE DRAWINGS

FIG. 1 is a block diagram of a system according to some embodiments.

FIG. 2 is a tabular representation of a portion of an Entities data structure according to some embodiments.

FIG. 3 is a flow diagram of a process according to some embodiments.

FIG. 4 is a diagram illustrating creation of entity clusters based on relation types according to some embodiments.

FIG. 5 is a tabular representation of a portion of an Entities data structure according to some embodiments.

FIG. 6 is a block diagram of a system according to some embodiments.

FIG. 7 is a tabular representation of a portion of a cluster index according to some embodiments.

FIG. 8 is a flow diagram of a process according to some embodiments.

FIG. 9 is an outward view of an interface for submitting a search query according to some embodiments.

FIG. 10 is an outward view of an interface for presenting search results according to some embodiments.

FIG. 11 is a flow diagram of a process according to some embodiments.

FIG. 12 is a flow diagram of a process according to some embodiments.

FIG. 13 is a table illustrating relevance score weights according to some embodiments.

FIG. 14 is a block diagram of an apparatus according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

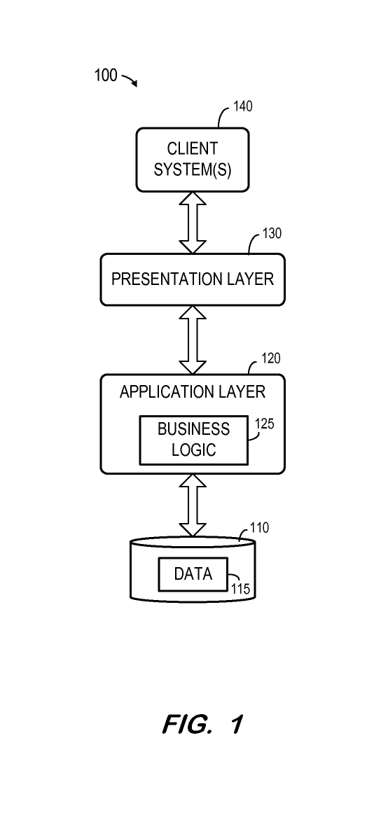

Some embodiments may be implemented using a hardware architecture such as that shown in FIG. 1. Application platform 100 includes database 110, which may comprise a relational database system as is known in the art. However, embodiments are not limited thereto. Database 110 stores data 115 indicating relations between entities, which may include people, organizations, or any other entity. Data 115 may comprise any data suitable for the processes described herein, and may be generated using any suitable system. For example, data 115 may be generated from disparate enterprise source data using a system described in aforementioned U.S. patent application Ser. No. 12/253,562.

Application layer 120 may provide access to data stored in database 110. This access may be provided through a reporting, dashboarding, and/or analysis framework supported by application layer 120. Application layer 120 may provide search engine functionality for searching data 115 according to some embodiments. Application layer 120 may also provide security and data distribution functions.

Application layer 120 includes business logic 125 for providing business functions based at least in part on data 115 of database 110. For example, business logic 125 may comprise program code executable by application platform 100 to perform any of the processes described herein. A portion of business logic 125 may run periodically in batch mode to associate cluster identifiers with entities and index the cluster identifiers as described below.

Presentation layer 130 includes program code to provide a user interface for accessing data 115 of database 110 and/or functions provided by business logic 125 via application layer 120. Client system(s) 140 may comprise any suitable device(s), such as a desktop computer, a laptop computer, a personal digital assistant, a tablet PC, and a smartphone. Client system(s) 140 may host the program code of presentation layer 130 (i.e., in a rich client architecture) or may access the code remotely, such as through a Web-based portal.

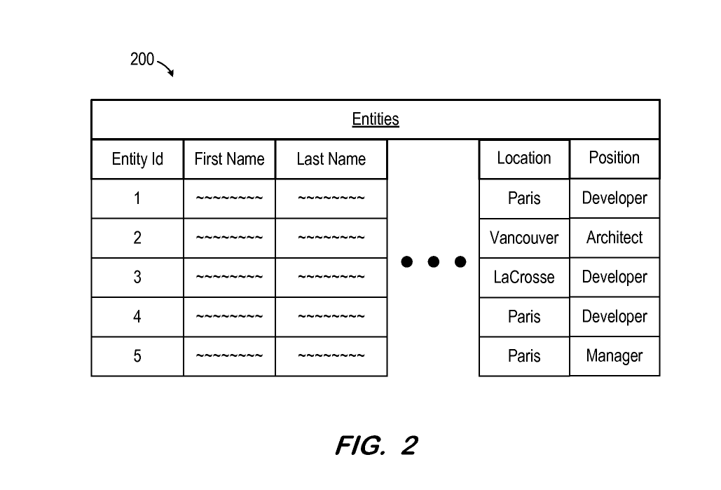

FIG. 2 is a tabular representation of a portion of Entities data structure 200 according to some embodiments. Structure 200 may be stored among data 115 of application platform 100. According to the illustrated example, each row of structure 200 provides information associated with an entity identified by the Entity Id column. Embodiments of Entities data structure 200 are not limited to any particular fields, and any type of data structure may be utilized to associate an entity with information according to some embodiments.

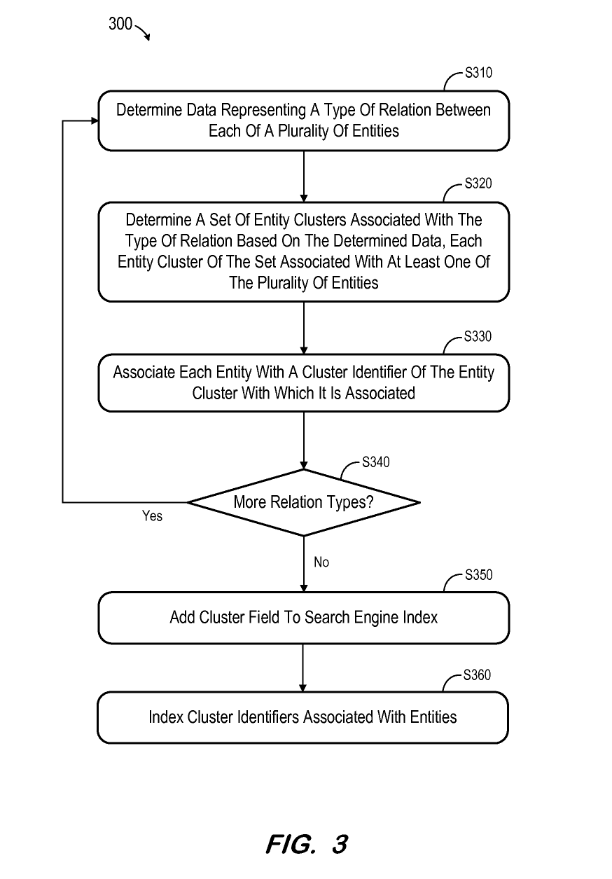

FIG. 3 is a flow diagram of process 300 according to some embodiments. Process 300 may be executed by hardware and embodied in program code stored on a non-transitory computer-readable medium. Process 300 may be performed by one or more elements of application platform 100, but embodiments are not limited thereto.

Generally, process 300 may be executed to associate cluster identifiers with entities, and to index these cluster identifiers to facilitate subsequent searching. As described with respect to business logic 125, this association and indexing may be executed as a batch process. The batch process may be run during periods of low usage (e.g., overnight) so as not to consume system resources during periods of high usage. Moreover, process 300 may be distributed among several processing nodes using known distributive computing techniques.

Initially, at S310, data representing a particular type of relation between each of a plurality of entities is determined. As described above, the determined data may represent email relations between the plurality of entities.

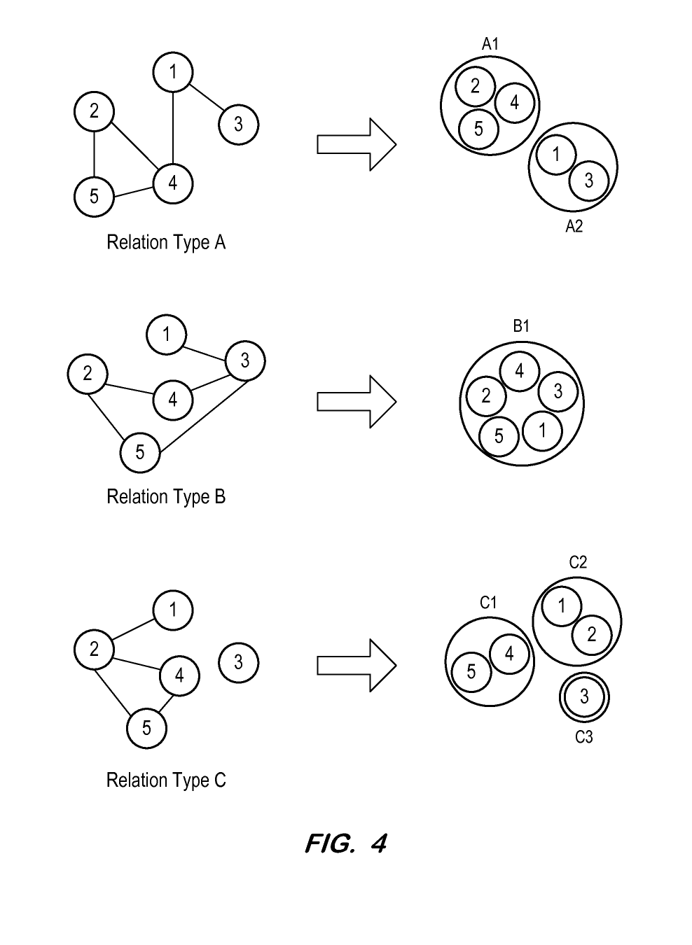

FIG. 4 illustrates data determined at S310 according to some embodiments. The graph labeled Relation Type A illustrates determined data representing a particular type of relation. For example, the determined data may represent email communications between Entities 1 through 5. The Relation Type A graph also indicates some associations reflected in the data. For example, the data may include greater than a threshold number of email communications between Entity 3 and Entity 1, and may include less than the threshold number of email communications between Entity 1 and Entity 4. The reflected associations may be based on any other factors relevant to the relation type (e.g., number of email communications labeled Urgent, number of email communications sent during non-business hours, size of average email communication, etc.).

Next, at S320, a set of entity clusters associated with the relation type is determined based on the data. Each entity cluster is associated with at least one of the plurality of entities. FIG. 4 illustrates the determination of entity clusters A1 and A2 based on the determined data. Entity clusters A1 and A2 may be determined based on any suitable characteristics of the determined data, and using any clustering technology that is or becomes known. As shown, Cluster A1 includes Entities 2, 4 and 5 and Cluster A2 includes Entities 1 and 3.

Each entity is associated with a cluster identifier at S330. The associated cluster identifier identifies the entity cluster with which the entity is associated. Continuing the present example, Entities 2, 4 and 5 are associated with the cluster identifier “A1” and Entities 1 and 3 are associated with the cluster identifier “A2”. This association may be persisted in a data structure using any suitable data schema.

At S340, it is determined whether any more relation types are of interest. S340 may comprise attempting to determine whether a set of data represents an additional relation type. As described above, the relation types represented in the data may include relation types based on business hierarchies (e.g., common manager, connected to a same third person within an organizational chart, common department), relation types based on communications (e.g., e-mail exchanges, telephone calls), and relation types based on activities (e.g., common project).

If so (e.g., the set of data specifies whether entities have worked on a same project), flow returns to S310 to determine data representing a next type of relation between each of the plurality of entities.

Flow continues through S320 and S330 as described above. With reference to FIG. 4, the graph labeled Relation Type B illustrates determined data representing a next relation type. The graphs of FIG. 4 are intended to simply reflect different relations between entities. Embodiments do not necessarily include generation of such graphs.

A single entity cluster is determined at S320 based on the data of Relation Type B. Accordingly, at S330, each of Entities 1 through 5 is associated with the cluster identifier “B1”. It will be assumed that yet another relation type is identified at S340, causing flow to return to S310 to determine data representing the next type of relation (e.g., Relation Type C of FIG. 4), to determine a next set of entity clusters (e.g., C1, C2 and C3), and to associate each entity with a cluster identifier (e.g., Entities 4 and 5—“C1”, Entities 1 and 2—“C2”, and Entity 3—“C3”).

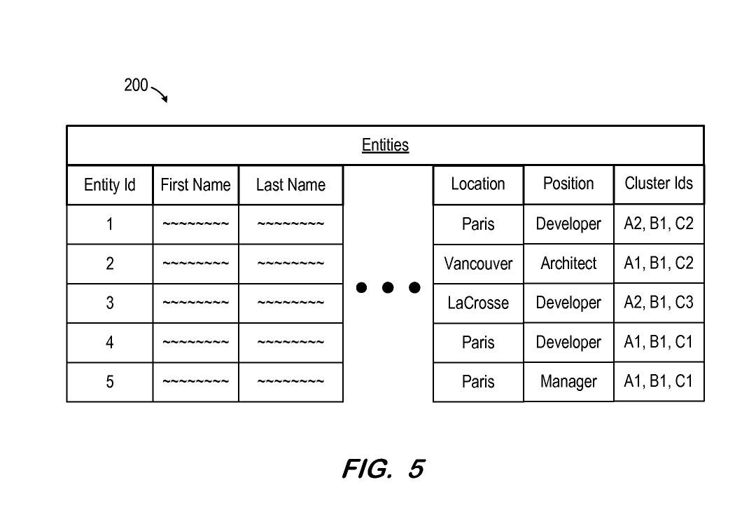

FIG. 5 illustrates Entities data structure 200 as modified at S330 of process 300. As shown, a Cluster Ids column has been added to associate particular entities with particular entity clusters. The associations shown in FIG. 5 reflect the entity clusters of FIG. 4. Embodiments are not limited to a single flat file for associating entities with clusters.

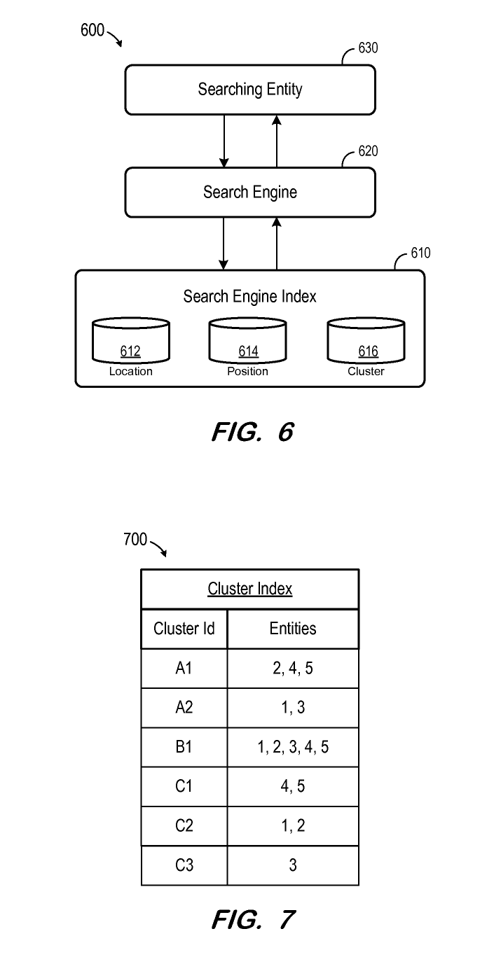

A cluster field is added to a search engine index at S350. S350 may be omitted if the search engine index already includes the cluster field. For illustration, FIG. 6 shows search architecture 600 after S350 according to some embodiments. Architecture 600 includes search engine index 610 with indices 612, 614 and 616. Each of indices 612, 614 and 616 is associated with a different field (i.e., name, office location, cluster). According to known systems, search engine 620 receives a search query from searching entity 630 and, in conjunction with search engine index 610, returns search results from the data stored in search engine index 610. Embodiments may be used in conjunction with any suitable searching system. According to some embodiments, client system 140, application layer 120 and database 110 of application platform 100 implement searching entity 630, search engine 620 and search engine index 610, respectively.

Returning to process 300, the cluster identifiers associated with the entities are indexed at S360. Any system for indexing that is or becomes known may be employed at S360. FIG. 7 shows Cluster Index table 700 according to the present example. Table 700 is an inverted index in which the indexed data (i.e., the cluster identifiers) are the keys and the associated Entities are the values.

As will be described below, subsequent processes may use the results of process 300 to present search query results based at least in part on the entity cluster to which the entities belong. Process 300 may be performed periodically to account for new data which may represent new relation types and/or new cluster-entity associations for existing relation types.

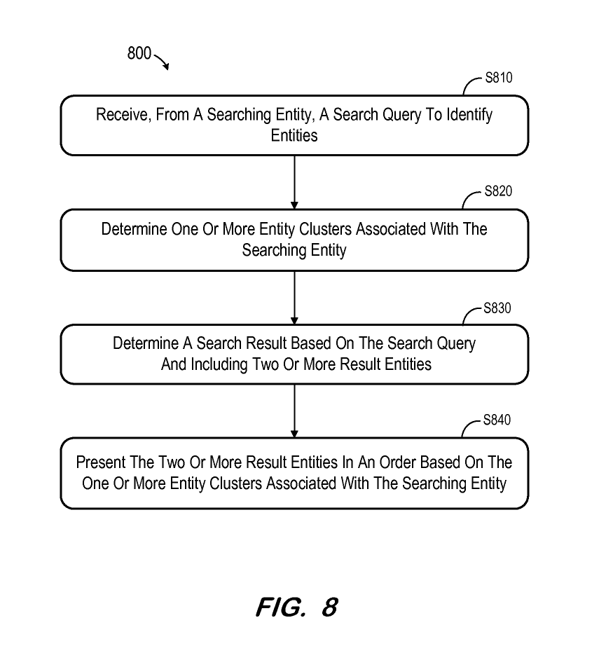

Process 800 of FIG. 8 may be performed by a search engine and/or application layer according to some embodiments. Process 800 may be performed after the determination of entity clusters and the association of entities with cluster identifiers described with respect to process 300. As will be evident from the description below, some embodiments of process 800 may be performed without prior indexing of cluster identifiers as described above.

A search query is received from an entity at S810. The search query is intended to identify particular entities. More specifically, the search query includes search terms and is intended to return “result entities” to which those search terms are relevant.

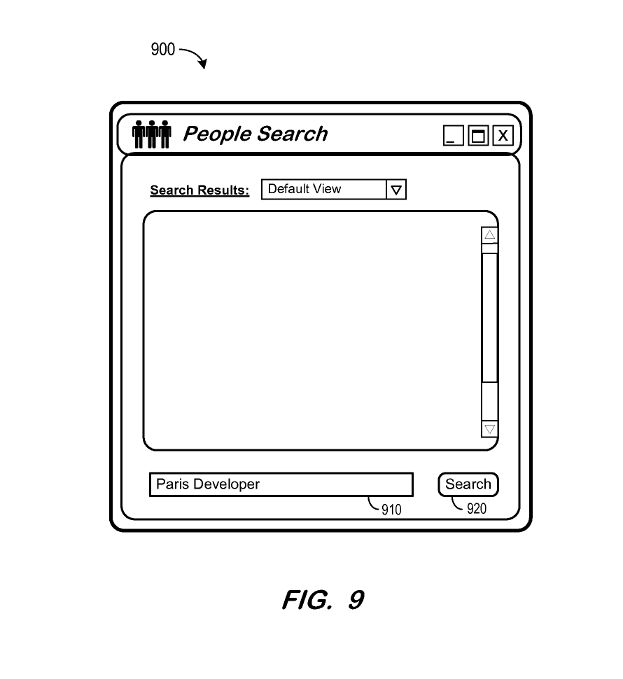

FIG. 9 illustrates user interface 900 from which a search query may be received according to some embodiments. User interface 900 may be displayed by client system 140 of platform 100 and/or searching entity 630 of architecture 600. As described above, interface 900 may be displayed via execution of program code of a rich client application, an applet in a Web browser, or any other suitable application.

User interface 900 includes input field 910 and Search button 920. Search terms are entered into input field 910 in order to identify one or more entities associated with the search terms. Selection of Search button 920 causes reception of a search query including the entered search terms. In one example, the search query is received by application layer 120 of application platform 100.

Next, at S820, one or more entity clusters associated with the searching entity are determined. Entity-entity cluster associations may be determined and stored prior to process 800 as described above with respect to process 300. Accordingly, S820 may include accessing these pre-stored associations. According to the present example, it will be assumed that the search query is received from an entity associated with Entity Id “3”. Therefore, with reference to Entities data structure 200, the entity clusters A2, B1 and C3 are determined at S820.

A search result is determined at S830 based on the search query. The search result includes two or more result entities. Any query-responsive searching system may be employed at S830. In some embodiments, the searching system includes a search engine and search engine index such as search engine 620 and search engine index 610. More specifically, search engine index 610 may index data associated with various entities and search engine 620 may identify two or more result entities based on the search terms, the indexed data, and its searching algorithms. Its searching algorithms may also associate a relevance score with each result entity as is known in the art.

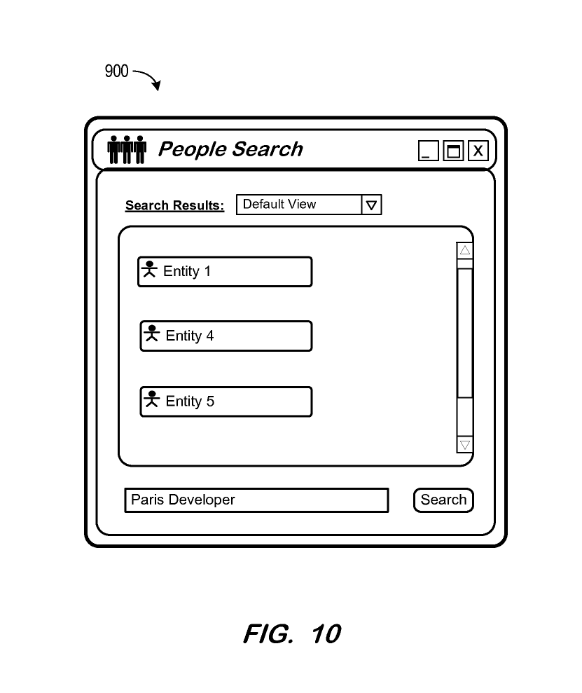

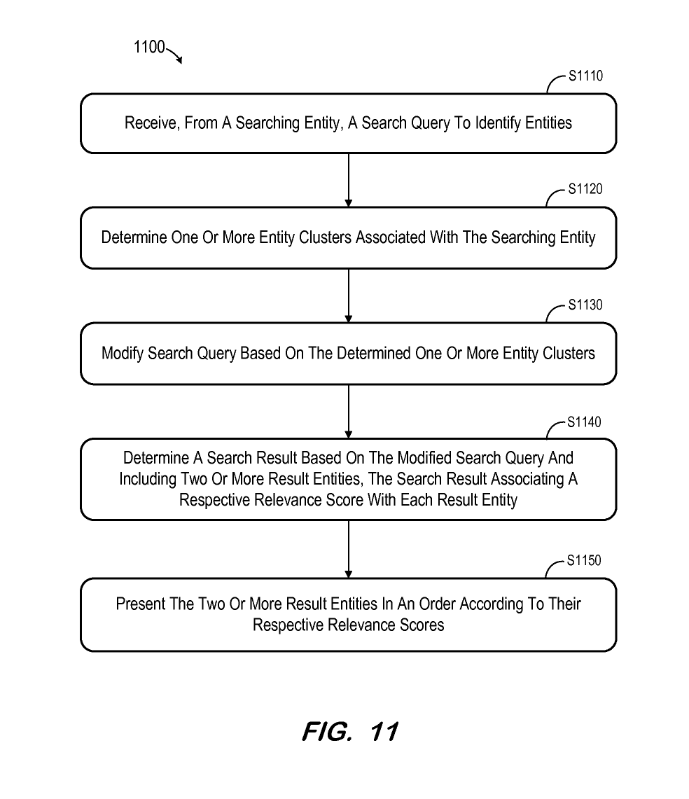

The two or more result entities are presented at S840. FIG. 10 illustrates interface 900 after S840 according to some embodiments. The two or more result entities are presented in an order which is based on the one or more entity clusters determined at S820. In the particular illustrated example, the entities associated with Entity Ids 1 and 4 are both associated with the search terms “Paris” and “developer”. However, Entity Id 1 shares two entity clusters (i.e., A2, B1) with Entity Id 3 (i.e., the searching entity), while Entity Id 4 shares only one entity cluster (i.e., B1) with Entity Id 3. As a result, the presentation of the result entities may be more appropriate to the requesting entity than that provided by conventional systems.

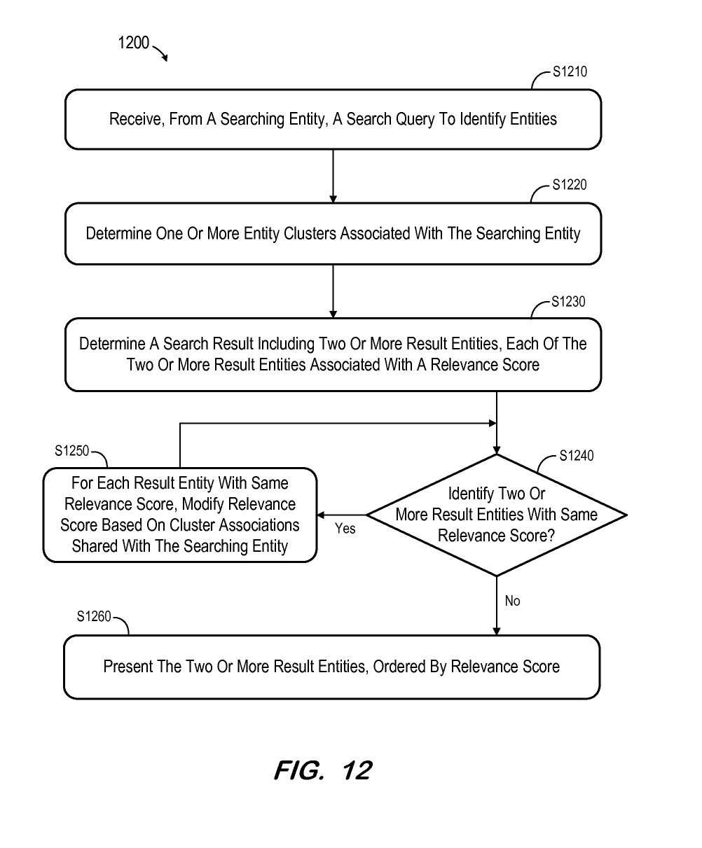

FIGS. 11 and 12 describe two alternative implementations of process 800. Embodiments are not limited to either of these two alternative implementations.

Beginning with process 1100 of FIG. 11, a search query is received from an entity at S1110. In this regard, S1110 and S1120 may proceed as described above with respect to S810 and S820 of process 800. Next, at S1130, the search query is modified based on the one or more entity clusters determined at S1120.

According to some embodiments, the query is modified by adding one or more entities to the search terms at S 1130. For example, the search terms “Paris” and “developer” may be received from the entity associated with Entity Id 3 at S1110. The entity clusters A2, B1 and C3 may then be identified at S1120. At S1130, a modified search query may be generated to indicate that “Paris” and “developer” are required search terms and that the determined entity clusters are optional search terms. More specifically, the received search query “Paris developer” may be translated at S1130 to “must (Paris, developer) may (cluster:A2) may (cluster:B1) may (cluster:C3)”. Embodiments are not limited to this example, and may modify the search query in any other manner based on the determined entity clusters.

A search result is determined at S1140 based on the modified search query. The search result includes two or more result entities, each of which is associated with a respective relevance score. The search may be performed using any suitable searching technology. In the case of the search terms of the present specific example, the search may be performed using indices 612, 614 and 616 of system 600. Accordingly, some embodiments of process 1100 require pre-processing steps S350 and S360 of process 300.

At S1140, the two or more result entities are presented in an order according to their respective relevance scores. Presentation of search results based on relevance scores is known in the art. However, by virtue of the modified search query, the relevance score associated with each result entity will depend in part on the entity clusters which the result entity shares with the searching entity. For example, a relevance score associated with Entity Id 1 may be greater than a relevance score associated with Entity Id 4 because Entity Id 1 shares two entity clusters with Entity Id 3. Therefore, FIG. 10 also provides an example of S1150 according to some embodiments.

Process 1100 may be used in conjunction with conventional systems for searching and for presenting search results. That is, process 1100 requires some non-conventional pre-search processing (e.g., S1120 and S1130) but advantageously allows the subsequent search and result presentation to proceed according to conventional techniques.

Turning to process 1200, S1210 and S1220 may also proceed as described with respect to S810 and S820. At S1230, a search result is determined based on the received search query. The search result includes two or more result entities, each of which is associated with a respective relevance score. S1230 may proceed based on the search query and using any searching system/algorithm that is or becomes known. Next, at S1240, it is determined whether one or more of the result entities is associated with a same relevance score.

For purposes of example, it is assumed that the search query “Paris developer” is received from the entity associated with Entity Id 3 at S1210. The entity clusters A2, B1 and C3 are identified at S 1220 as described above. The following search result is then obtained at S1230 based on the search query “Paris developer”: Entity Id 1 (relevance score 100%); Entity Id 4 (relevance score 100%); and Entity Id 5 (relevance score 50%). Accordingly, flow proceeds from S1240 to S1250 due to the identical relevance scores associated with Entity Id 1 and Entity Id 4.

At S1250, each of the identical relevance scores is modified based on cluster associations shared with the searching entity. That is, for each result entity having the identical relevance score, its relevance score is modified based on the one or more entity clusters determined at S1220 and on one or more entity clusters associated with the result entity.

According to some embodiments, the relevance scores are modified at S1250 based on the entity clusters which are shared between the searching entity and the respective result entities, and also on the relation types associated with the shared entity clusters. For example, and returning to FIG. 4, it will be assumed that weightings of 0.25, 0.05 and 0.70 are associated with Relation Types A, B and C, respectively. Since Entity Id 1 shares entity clusters A2 and B1 with the searching entity, a weighting of (0.25+0.05)=0.30 is determined at S1250 for Entity Id 1. Similarly, a weighting of 0.05 is determined at S1250 for Entity Id 1 due to shared entity cluster B1.

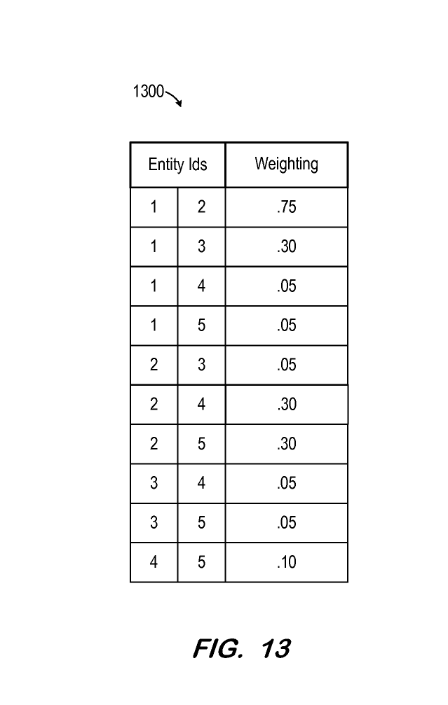

To further illustrate the calculation of weightings according to some embodiments, data structure 1300 of FIG. 13 associates each pair of Entity Ids with a weighting. The weighting is based on the example weightings for each relation type mentioned above (i.e., 0.25, 0.05 and 0.30) as well as on the Cluster Ids of Entities data structure 200.

The determined weightings may modify the relevance scores in S1250 using any combination of mathematical operands and/or other values. In one example, the weightings are added to the relevance scores as percentages. Accordingly, in the present example, the relevance score associated with Entity Id 1 is modified to 130% and the relevance score associated with Entity Id 4 is modified to 105%.

Flow returns to S1240 to determine if any other result entities are associated with identical relevance scores. If not, the two or more result entities are presented at S1260 in an order according to their respective relevance scores, which may or may not have been modified at S1250. Process 1200 therefore allows the presentation of the search results to proceed according to conventional techniques (i.e., according to relevance score), and does not require pre-search modification of the search query. Moreover, some embodiments of process 1200 do not require prior indexing of the Cluster Ids as described above.

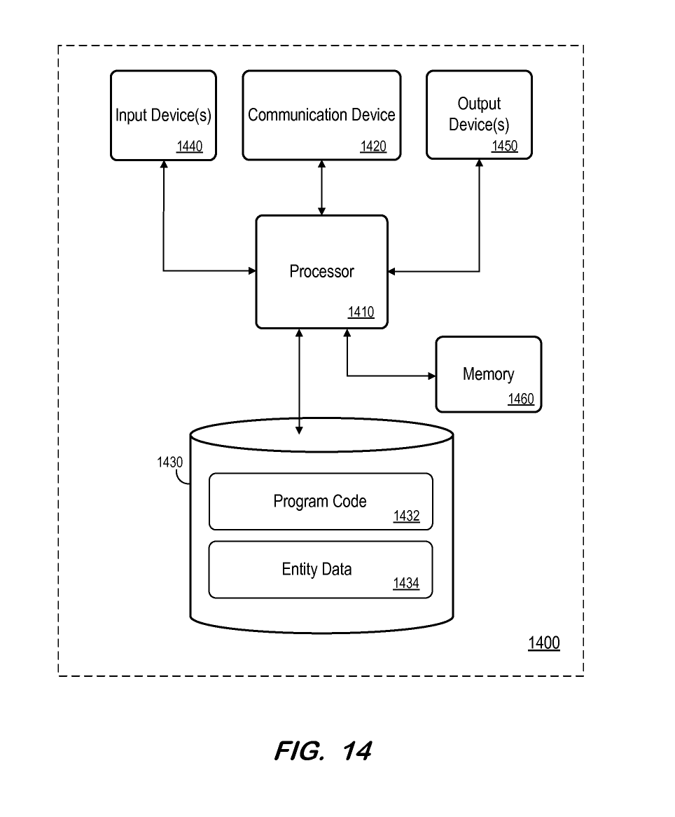

FIG. 14 is a block diagram of apparatus 1400 according to some embodiments. Apparatus 1400 may comprise a general-purpose computing apparatus and may execute program code to perform any of the functions described herein. Apparatus 1400 may comprise an implementation of application platform 100 and/or system 600. Apparatus 1400 may include other unshown elements according to some embodiments.

Apparatus 1400 includes processor 1410 operatively coupled to communication device 1420, data storage device 1430, one or more input devices 1440, one or more output devices 1450 and memory 1460. Communication device 1420 may facilitate communication with external devices, such as an external design tool. Input device(s) 1440 may comprise, for example, a keyboard, a keypad, a mouse or other pointing device, a microphone, knob or a switch, an infra-red (IR) port, a docking station, and/or a touch screen. Input device(s) 1440 may be used, for example, to enter information into apparatus 1400. Output device(s) 1450 may comprise, for example, a display (e.g., a display screen) a speaker, and/or a printer.

Data storage device 1430 may comprise any appropriate persistent storage device, including combinations of magnetic storage devices (e.g., magnetic tape, hard disk drives and flash memory), optical storage devices, Read Only Memory (ROM) devices, etc., while memory 1460 may comprise Random Access Memory (RAM).

Program code 1432 may be executed by processor 1410 to cause apparatus 1400 to perform any one or more of the processes described herein. Embodiments are not limited to execution of these processes by a single apparatus. Entity data 1434 may include any type of data structures of information associated with entities, from which relations therebetween and associated entity clusters may be determined. Data storage device 1430 may also store data and other program code for providing additional functionality and/or which are necessary for operation thereof, such as device drivers, operating system files, etc.

The foregoing diagrams represent logical architectures for describing processes according to some embodiments, and actual implementations may include more or different components arranged in other manners. Moreover, each system described herein may be implemented by any number of devices in communication via any number of other public and/or private networks. Two or more devices of may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

The embodiments described herein are solely for the purpose of illustration. Those in the art will recognize that other embodiments may be practiced with modifications and alterations limited only by the claims.

What is claimed is:

1. A method implemented by a computer in response to execution of program code by a processor of said computer, comprising:
receiving, from an entity, a search query to identify entities;
determining one or more entity clusters associated with the entity;
determining a search result based on the search query, the search result including two or more result entities; and
presenting the two or more result entities in an order based on the one or more entity clusters.

2. A method according to claim 1, further comprising:
modifying the search query based on the determined one or more entity clusters,
wherein the search result is determined based on the modified search query and associates a respective relevance score with each result entity, a relevance score indicating a relevance of a result entity to the modified search query, and
wherein the two or more result entities are presented according to their respective relevance scores.

3. A method according to claim 2, wherein the search query comprises at least one search term, and wherein modifying the search query comprises:
modifying the search query to indicate that the at least one search term is a required search term and to indicate that each of the one or more entity clusters is an optional search term.

4. A method according to claim 1, wherein each of the two or more result entities is associated with a respective relevance score, further comprising:
determining that two of the two or more result entities are associated with a same relevance score; and
modifying the respective relevance score associated with each of the two of the two or more result entities based on the one or more entity clusters associated with the entity, and on entity clusters associated with each of the two of the two or more result entities,
wherein the two of the two or more result entities are presented according to their modified relevance scores.

5. A method according to claim 4, wherein modifying the relevance score comprises:
for each of the two of the two or more result entities:
determining a second one or more entity clusters associated with the result entity and with the entity;
determining an associated type of relation for each of the second one or more entity clusters;
determining a weighting associated with each of the one or more associated types of relations; and
modifying the relevance score associated with the entity based on the one or more weightings.

6. A method according to claim 1, further comprising:
determining data representing a first type of relation between each of a plurality of entities;
determining a first set of entity clusters associated with the first type of relation based on the determined data, each entity cluster of the first set of entity clusters associated with at least one of the plurality of entities;
associating each of the plurality of entities with at least one cluster identifier of the entity cluster of the first set of entity clusters with which it is associated; and
indexing the cluster identifiers associated with each of the plurality of entities.

7. A method according to claim 6, further comprising:
determine second data representing a second type of relation between each of the plurality of entities;
determining a second set of entity clusters associated with the second type of relation based on the determined second data, each entity cluster of the second set of entity clusters associated with at least one of the plurality of entities; and
associating each of the plurality of entities with at least one second cluster identifier of the entity cluster of the second set of entity clusters with which it is associated,
wherein indexing the cluster identifiers comprises indexing the second cluster identifiers associated with each of the plurality of entities.

8. A computer-readable medium having stored thereon program code, the program code executable by a computer to:
receive, from an entity, a search query to identify entities;
determine one or more entity clusters associated with the entity;
determine a search result based on the search query, the search result including two or more result entities; and
present the two or more result entities in an order based on the one or more entity clusters.

9. A medium according to claim 8, the program code further executable by a computer to:
modify the search query based on the determined one or more entity clusters,
wherein the search result is determined based on the modified search query and associates a respective relevance score with each result entity, a relevance score indicating a relevance of a result entity to the modified search query, and
wherein the two or more result entities are presented according to their respective relevance scores.

10. A medium according to claim 9, wherein the search query comprises at least one search term, and wherein modification of the search query comprises:
modification of the search query to indicate that the at least one search term is a required search term and to indicate that each of the one or more entity clusters is an optional search term.

11. A medium according to claim 8, wherein each of the two or more result entities is associated with a respective relevance score, the program code further executable by a computer to:
determine that two of the two or more result entities are associated with a same relevance score; and
modify the respective relevance score associated with each of the two of the two or more result entities based on the one or more entity clusters associated with the entity, and on entity clusters associated with each of the two of the two or more result entities,
wherein the two of the two or more result entities are presented according to their modified relevance scores.

12. A medium according to claim 11, wherein the program code executable by a computer to modify the relevance score comprises program code further executable by a computer to:
for each of the two of the two or more result entities:
determine a second one or more entity clusters associated with the result entity and with the entity;
determine an associated type of relation for each of the second one or more entity clusters;
determine a weighting associated with each of the one or more associated types of relations; and
modify the relevance score associated with the entity based on the one or more weightings.

13. A medium according to claim 8, the program code further executable by a computer to:
determine data representing a first type of relation between each of a plurality of entities;
determine a first set of entity clusters associated with the first type of relation based on the determined data, each entity cluster of the first set of entity clusters associated with at least one of the plurality of entities;
associate each of the plurality of entities with at least one cluster identifier of the entity cluster of the first set of entity clusters with which it is associated; and
index the cluster identifiers associated with each of the plurality of entities.

14. A medium according to claim 13, the program code further executable by a computer to:
determine second data representing a second type of relation between each of the plurality of entities;
determine a second set of entity clusters associated with the second type of relation based on the determined second data, each entity cluster of the second set of entity clusters associated with at least one of the plurality of entities; and
associate each of the plurality of entities with at least one second cluster identifier of the entity cluster of the second set of entity clusters with which it is associated,
wherein indexing the cluster identifiers comprises indexing the second cluster identifiers associated with each of the plurality of entities.

15. A system comprising:
an application platform including a processor operative to:
receive, from an entity, a search query to identify entities;
determine one or more entity clusters associated with the entity;
determine a search result based on the search query, the search result including two or more result entities; and
present the two or more result entities in an order based on the one or more entity clusters.

16. A system according to claim 15, the application platform further operative to:
modify the search query based on the determined one or more entity clusters,
wherein the search result is determined based on the modified search query and associates a respective relevance score with each result entity, a relevance score indicating a relevance of a result entity to the modified search query, and
wherein the two or more result entities are presented according to their respective relevance scores.

17. A system according to claim 16, wherein the search query comprises at least one search term, and wherein modification of the search query comprises:
modification of the search query to indicate that the at least one search term is a required search term and to indicate that each of the one or more entity clusters is an optional search term.

18. A system according to claim 15, wherein each of the two or more result entities is associated with a respective relevance score, the application platform further operative to:
determine that two of the two or more result entities are associated with a same relevance score; and
modify the respective relevance score associated with each of the two of the two or more result entities based on the one or more entity clusters associated with the entity, and on entity clusters associated with each of the two of the two or more result entities,
wherein the two of the two or more result entities are presented according to their modified relevance scores.

19. A system according to claim 18, wherein modification of the relevance score comprises:
for each of the two of the two or more result entities:
determination of a second one or more entity clusters associated with the result entity and with the entity;
determination of an associated type of relation for each of the second one or more entity clusters;
determination of a weighting associated with each of the one or more associated types of relations; and
modification of the relevance score associated with the entity based on the one or more weightings.

20. A system according to claim 15, the application platform further operative to:
determine data representing a first type of relation between each of a plurality of entities;
determine a first set of entity clusters associated with the first type of relation based on the determined data, each entity cluster of the first set of entity clusters associated with at least one of the plurality of entities;
associate each of the plurality of entities with at least one cluster identifier of the entity cluster of the first set of entity clusters with which it is associated; and
index the cluster identifiers associated with each of the plurality of entities.

21. A system according to claim 20, the application platform further operative to:
determine second data representing a second type of relation between each of the plurality of entities;
determine a second set of entity clusters associated with the second type of relation based on the determined second data, each entity cluster of the second set of entity clusters associated with at least one of the plurality of entities; and
associate each of the plurality of entities with at least one second cluster identifier of the entity cluster of the second set of entity clusters with which it is associated,
wherein indexing the cluster identifiers comprises indexing the second cluster identifiers associated with each of the plurality of entities.
